(19) United States
(12) Patent Application Publication
(10) Pub. No.: US 2026/0177492 A1
(43) Pub. Date: Jun. 25, 2026

(54) ANALYSIS OF MIXTURE USING COMBINATION OF SPECTROSCOPY AND MACHINE LEARNING

(71) Applicants: William Marsh Rice University, Houston, TX (US); University of Georgia Research Foundation, Inc., Athens, GA (US); Baylor College of Medicine, Houston, TX (US)

(72) Inventors: Mary M. Bajomo, Houston, TX (US); Yilong Ju, Houston, TX (US); Yiping Zhao, Athens, GA (US); Oara Neumann, Houston, TX (US); Peter J. Norlander, Houston, TX (US); Ankit Patel, Houston, TX (US); Nancy J. Halas, Houston, TX (US)

(73) Assignees: William Marsh Rice University, Houston, TX (US); University of Georgia Research Foundation, Inc., Athens, GA (US); Baylor College of Medicine, Houston, TX (US)

(21) Appl. No.: 19/125,643

(22) PCT Filed: Oct. 31, 2023
(86) PCT No.: PCT/US2023/036483

§ 371 Date: Apr. 29, 2025

Related U.S. Application Data
(60) Provisional application No. 63/421,094, filed on Oct. 31, 2022.

(51) Int. Cl. G01N 21/65

(52) U.S. Cl. CPC G01N 21/658

(57) ABSTRACT

A method for analyzing a mixture includes obtaining a first spectrum of the mixture comprising a plurality of components; selecting at least one position on the spectrum; and estimating a mixing weight for each of the components using an algorithm based on an intensity of the at least one position. A system for analyzing a mixture includes a spectrometer configured to obtain a first spectrum of the mixture comprising a plurality of components; a processor configured to select at least one position on the spectrum and estimate a mixing weight for each of the components using an algorithm based on an intensity of the at least one position.

### STATEMENT REGARDING FEDERALLY SPONSORED RESEARCH

This invention was made with government support under Grant No. P42ES027725 awarded by the National Institutes of Health. The government has certain rights in the invention.

### BACKGROUND

Chemical contaminants are frequently found in mixtures of similar molecules; their identification typically starts with time-consuming separation steps prior to identification of individual components. There exists a need to develop a strategy to examine whether chemical separations could be replaced by a Machine Learning-based analysis of the mixture. This invention was funded in part by the Robert A. Welch Foundation under Welch Grant Nos. C-1220 and C-1222.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for analyzing a mixture, comprising: obtaining a first spectrum of the mixture comprising a plurality of components; selecting at least one position on the spectrum; and estimating a mixing weight for each of the components using an algorithm based on an intensity of the at least one position. In one or more embodiments, the components in the mixture include one or more of polycyclic aromatic hydrocarbons (PAHs). In one or more embodiments, the first spectrum is a Raman scattering spectrum. In one or more embodiments, the first spectrum is obtained by Surface-Enhanced Raman Spectroscopy (SERS). In one or more embodiments, the first spectrum is obtained on a nanostructured metallic substrate. In one or more embodiments, the method further comprises obtaining a second spectrum of one or more of the components as an input of the algorithm. In one or more embodiments, the first spectrum is an averaged spectrum of a plurality of measurements. In one or more embodiments, the algorithm comprises a compression algorithm and a de-mixing algorithm. In one or more embodiments, the compression algorithm comprises a machine learning algorithm. In one or more embodiments, the machine learning algorithm comprises a clustering algorithm.

In one aspect, embodiments disclosed herein relate to a system for analyzing a mixture, comprising: a spectrometer configured to obtain a first spectrum of the mixture comprising a plurality of components; and a processor configured to select at least one position on the spectrum and estimate a mixing weight for each of the components using an algorithm based on an intensity of the at least one position. In one or more embodiments, the components in the mixture include one or more of polycyclic aromatic hydrocarbons (PAHs). In one or more embodiments, the spectrometer is a Raman spectroscopy. In one or more embodiments, the first spectrum is obtained by Surface-Enhanced Raman Spectroscopy (SERS). In one or more embodiments, the first spectrum is obtained on a nanostructured metallic substrate. In one or more embodiments, the spectrometer is configured to obtain a second spectrum of one or more of the components as an input of the algorithm. In one or more embodiments, the first spectrum is an averaged spectrum of a plurality of measurements. In one or more embodiments, the algorithm comprises a compression algorithm and a de-mixing algorithm. In one or more embodiments, the compression algorithm comprises a machine learning algorithm. In one or more embodiments, the machine learning algorithm comprises a clustering algorithm.

Other aspects and advantages of the claimed subject matter will be apparent from the following description and the appended claims.

### BRIEF DESCRIPTION OF DRAWINGS

FIG. 1 depicts an example diagram of a computer, in accordance with one or more embodiments.

FIG. 2A shows a scheme of SERS system according to one or more embodiments.

FIG. 2B shows experimental extinction spectra according to one or more embodiments.

FIG. 2C shows spatial distribution of the calculated electric field enhancement according to one or more embodiments.

FIG. 2D shows SEM image of SERS substrate according to one or more embodiments.

FIG. 2E shows a scheme of machine learning-based reconstruction according to one or more embodiments.

FIG. 3A shows SERS spectrum of the mixture of PAHs, SERS spectra of the components of the mixture, and corresponding machine learning based demixed component for the mixture according to one or more embodiments.

FIG. 3B shows SERS spectra of the mixture of PAHs, components of the mixture, and corresponding machine learning based demixed component for the mixture according to one or more embodiments.

FIG. 3C shows SERS spectra of the mixture of PAHs, components of the mixture, and corresponding machine learning based demixed component for the mixture according to one or more embodiments.

FIG. 3D shows SERS spectra of the mixture of PAHs, components of the mixture, and corresponding machine learning based demixed component for the mixture according to one or more embodiments.

FIG. 3E shows SERS spectra of the mixture of PAHs, components of the mixture, and corresponding machine learning based demixed component for the mixture according to one or more embodiments.

FIG. 3F shows SERS spectra of the mixture of PAHs, components of the mixture, and corresponding machine learning based demixed component for the mixture according to one or more embodiments.

FIG. 4A shows spectra of PAHs with different ratios according to one or more embodiments.

FIG. 4B shows intensities of PAHs at 589 and 1382 cm⁻¹ according to one or more embodiments.

FIG. 4C shows spectra of mixture components according to one or more embodiments.

FIG. 4D shows spectra of PAHs with different ratios according to one or more embodiments.

FIG. 4E shows intensities of PAHs at 589 and 1382 cm⁻¹ according to one or more embodiments.

FIG. 4F shows spectra of mixture components according to one or more embodiments.

FIG. 5A shows SERS spectra of PAHs in different mixture ratios according to one or more embodiments.

FIG. 5B shows SERS spectra of a mixture of PAHs, components of the mixture, and corresponding derived components (DCs) according to one or more embodiments.

FIG. 6A shows area under the precision-recall curve (AUPRC) for mixtures according to one or more embodiments.

FIG. 6B shows proportion of matched PAHs after demixing according to one or more embodiments.

### DETAILED DESCRIPTION

In the following, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

In one aspect, embodiments disclosed herein relate to a system and a method for chemical detection using Surface Enhanced Raman Spectroscopy (SERS) and machine learning.

Surface Enhanced Raman Spectroscopy (SERS) holds exceptional promise as a streamlined chemical detection strategy for biological and environmental contaminants compared to current laboratory methods. Priority pollutants such as polycyclic aromatic hydrocarbons (PAHs), detectable in water and soil worldwide and known to induce multiple adverse health effects upon human exposure, are typically found in multicomponent mixtures. By combining the molecular fingerprinting capabilities of SERS with the signal separation and detection capabilities of machine learning (ML), the present disclosure provides a method to examine whether individual PAHs can be identified through an analysis of the SERS spectra of multicomponent PAH mixtures. The present disclosure provides an unsupervised ML method, referred to as Characteristic Peak Extraction (CaPE), which is a novel dimensionality reduction algorithm that extracts characteristic SERS peaks based on counts of detected peaks of the mixture. By analyzing the SERS spectra of two-component and four-component PAH mixtures where the concentration ratios of the various components vary, this algorithm is able to extract the spectra of each unknown component in the mixture of unknowns, which is then subsequently identified against a SERS spectral library of PAHs. Combining the molecular fingerprinting capabilities of SERS with the signal separation and detection capabilities of ML, this effort is a first step towards the computational demixing of unknown chemical components occurring in complex multicomponent mixtures.

Here the present disclosure provides a strategy to examine whether chemical separations, for example to identify chemical contaminants, could be replaced by a Machine Learning-based analysis of the mixture. Machine Learning strategies have been developed to identify individual sources in a complex mixture of signals, known as the “cocktail party problem”, where a number of people are talking simultaneously but the listener is trying to follow only one of the discussions. The present disclosure provides an analysis to the spectroscopic signal of complex mixtures of chemicals to examine how well Machine Learning can distinguish the individual chemical components with no prior knowledge of their identity.

Despite its discovery nearly 50 years ago, Surface-Enhanced Raman Spectroscopy (SERS) is still maturing towards a practical analytical technique for ultrasensitive chemical detection. Raman scattering, typically a very inefficient process, is enhanced by many orders of magnitude for molecules positioned in the direct vicinity of nanostructured metallic substrates, resulting in detailed SERS spectra that make detection and identification at low concentrations possible. While SERS remains an active topic of research, its potential for high sensitivity, portability, and straightforward sample preparation could provide major advances in chemical detection/identification for biological or environmental samples over current methods that combine chromatography and mass spectrometry. However, given the multicomponent chemical complexity of environmental and biological samples, additional strategies are likely needed for this spectroscopic method to fulfill its technological promise.

A family of priority pollutants of great interest has been polycyclic aromatic hydrocarbons (PAHs), a hazardous class of chemicals whose molecular structure consists primarily of multiple fused benzene rings. PAHs are typically generated from incomplete combustion, frequently of fossil fuels, and are detectable in virtually every river and estuary worldwide. In biological systems, PAH metabolites bind covalently to cellular macromolecules, including DNA, and are well-known carcinogens. In biological and environmental samples, they are typically found as multicomponent PAH mixtures and in complex matrices, which greatly complicates their detection and identification. Chemical methods that attempt to favor selective PAH detection on functionalized SERS substrates have been demonstrated, along with extraction protocols, to reduce background effects due to complex matrices.

Given these challenges, the incorporation of machine learning-based strategies for digital separation or demixing together with SERS is a highly promising approach towards streamlined PAH detection and identification. Thus far, machine learning (ML) strategies have been combined with SERS to address problems such as the profiling of wine flavors and numerous biomedical applications. By combining the molecular fingerprinting capabilities of SERS with the signal separation and detection capabilities of machine learning, one can begin to investigate whether individual PAHs can be identified by analyzing the SERS spectra of multicomponent PAH mixtures: an approach referred to as “computational chromatography.” One or more embodiments of the present disclosure provides unsupervised demixing (i.e., no library of known spectra is required). A library of known PAHs and mixtures might be used only for hyperparameter tuning and evaluating the demixing algorithms. However, even for these purposes, a library may be avoided, supposing one having ordinary skill in the art has some prior knowledge about the spectral characteristics of the components and use the performance on some downstream tasks for evaluation.

The demixing of SERS mixtures is an example of the blind source separation problem in ML, where measurement data are often modeled as an additive combination of underlying sources. A variety of methods have been designed to demix mixtures and recover the sources, among which independent component analysis (ICA) and nonnegative matrix factorization (NMF) are the most frequently used. Past attempts to demix spectra of mixtures typically have involved applying conventional ICA to a synthetic dataset, or to the SERS of a mixture containing only two components. For mixtures with more components, auxiliary algorithms have been designed to aid ICA, but the task performed was only to separate the background from the mixture. There are also many variants of ICA and NMF that might be very useful for demixing, as they introduce different assumptions and constraints to the problem, such as nonnegative ICA (NICA), sparse ICA (SICA), and near-separable NMF (NSNMF). NSNMF methods, such as XRAY and SPA, are a bit different since they directly pick the least mixed recordings from data as the estimated sources.

A key impediment to demixing is the presence of noise. Noise in the peak amplitudes and/or locations makes it difficult if not impossible to discriminate between two similar molecules. One effective strategy for dealing with this is to use a dimensionality reduction (i.e., compression) algorithm to filter out the less discriminating non-characteristic peaks. Such compression is especially important for NSNMF methods, because they search for extreme spectra, namely those that are most dissimilar from all other spectra in the dataset. Compression also enables demixing methods to run faster, an additional benefit. The most important information for identifying PAHs using SERS is their spectra, which consist of several prominent Raman-active spectral features, which is referred to as characteristic peaks (CPs): the background and noisy peaks are far less useful. For SERS of PAHs, roughly ten CPs can serve as a sufficiently discriminative fingerprint for the full molecular Raman spectrum, which often has many more peaks/dimensions. Hence, for a mixture of C components, only roughly ˜10 C dimensions is needed. Examples of existing data compression algorithms designed for NSNMF include QR decomposition, structured random, and Count-Gauss. All peaks other than the CPs may be referred to as non-characteristic peaks (NCPs). None of the existing data compression algorithms or demixing methods are designed to extract and exploit the CPs, which becomes especially difficult for CPs with relatively low intensities. Moreover, these algorithms are not robust to local spectral shifts of resonant peaks, a frequently observed property in SERS spectra due to the varying interactions of molecules with SERS substrates.

One or more embodiments of the present disclosure relates to a method that combines SERS and ML for the identification of individual components from the SERS spectra of a complex mixture of PAHs. One or more embodiments of the present disclosure relate to Characteristic Peak Extraction (CaPE), a novel data compression algorithm that extracts characteristic peaks from SERS spectra based on counts at locations of detected peaks of the mixture. CaPE has two unique advantages over existing ML algorithms: (1) it estimates CP locations from a set of mixture SERS spectra containing any unknown components by selecting the spectral locations where peaks occur more frequently rather than just the specific locations of high-intensity peaks; and (2) it tolerates local frequency shifts of CPs, identifying peaks with small shifts across recordings as a single peak by means of a specialized clustering algorithm. This combination of (i) chemical sensing where SERS spectra are collected at different relative PAH concentrations and (ii) demixing algorithms that can deal with small frequency shifts typically inherent in SERS spectra, enables the spectroscopic identification of individual PAHs from samples of a complex mixture in an unsupervised manner.

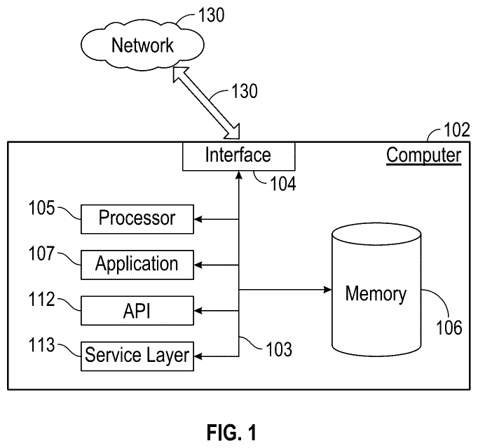

The computations mentioned in this disclosure may be performed by a computer, such as the computer (102) in FIG. 1. In that regard, FIG. 1 depicts a block diagram of a computer (102) used to provide computational functionalities associated with described algorithms, methods, functions, processes, flows, and procedures as described in this disclosure, according to one or more embodiments. The illustrated computer (102) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (102) may include a computer that includes an input device, such as a keypad, keyboard, touch screen, or other device that can accept user information, and an output device that conveys information associated with the operation of the computer (102), including digital data, visual, or audio information (or a combination of information), or a GUI.

The computer (102) can serve in a role as a client, network component, a server, a database or other persistency, or any other component (or a combination of roles) of a computer system for performing the subject matter described in the instant disclosure. In some implementations, one or more components of the computer (102) may be configured to operate within environments, including cloud-computing-based, local, global, or other environments (or a combination of environments).

At a high level, the computer (102) is an electronic computing device operable to receive, transmit, process, store, or manage data and information associated with the described subject matter. According to some implementations, the computer (102) may also include or be communicably coupled with an application server, e-mail server, web server, caching server, streaming data server, business intelligence (BI) server, or other server (or a combination of servers).

The computer (102) can receive requests over network (130) from a client application (for example, executing on another computer (102) and responding to the received requests by processing the said requests in an appropriate software application. In addition, requests may also be sent to the computer (102) from internal users (for example, from a command console or by other appropriate access method), external or third-parties, other automated applications, as well as any other appropriate entities, individuals, systems, or computers.

Each of the components of the computer (102) can communicate using a system bus (103). In some implementations, any or all of the components of the computer (102), both hardware or software (or a combination of hardware and software), may interface with each other or the interface (104) (or a combination of both) over the system bus (103) using an application programming interface (API) (112) or a service layer (113) (or a combination of the API (112) and service layer (113). The API (112) may include specifications for routines, data structures, and object classes. The API (112) may be either computer-language independent or dependent and refer to a complete interface, a single function, or even a set of APIs. The service layer (113) provides software services to the computer (102) or other components (whether or not illustrated) that are communicably coupled to the computer (102). The functionality of the computer (102) may be accessible for all service consumers using this service layer. Software services, such as those provided by the service layer (113), provide reusable, defined business functionalities through a defined interface. For example, the interface may be software written in JAVA, C++, or other suitable language providing data in extensible markup language (XML) format or another suitable format. While illustrated as an integrated component of the computer (102), alternative implementations may illustrate the API (112) or the service layer (113) as stand-alone components in relation to other components of the computer (102) or other components (whether or not illustrated) that are communicably coupled to the computer (102). Moreover, any or all parts of the API (112) or the service layer (113) may be implemented as child or sub-modules of another software module, enterprise application, or hardware module without departing from the scope of this disclosure.

The computer (102) includes an interface (104). Although illustrated as a single interface (1304) in FIG. 1, two or more interfaces (104) may be used according to particular needs, desires, or particular implementations of the computer (102). The interface (104) is used by the computer (102) for communicating with other systems in a distributed environment that are connected to the network (130). Generally, the interface (104) includes logic encoded in software or hardware (or a combination of software and hardware) and operable to communicate with the network (130). More specifically, the interface (104) may include software supporting one or more communication protocols associated with communications such that the network (130) or interface's hardware is operable to communicate physical signals within and outside of the illustrated computer (102).

The computer (102) includes at least one computer processor (105). Although illustrated as a single computer processor (105) in FIG. 1, two or more processors may be used according to particular needs, desires, or particular implementations of the computer (102). Generally, the computer processor (105) executes instructions and manipulates data to perform the operations of the computer (102) and any algorithms, methods, functions, processes, flows, and procedures as described in the instant disclosure.

The computer (102) also includes a memory (106) that holds data for the computer (1302) or other components (or a combination of both) that can be connected to the network (130). The memory may be a non-transitory computer readable medium. For example, memory (106) can be a database storing data consistent with this disclosure. Although illustrated as a single memory (106) in FIG. 13, two or more memories may be used according to particular needs, desires, or particular implementations of the computer (102) and the described functionality. While memory (106) is illustrated as an integral component of the computer (102), in alternative implementations, memory (1306) can be external to the computer (102).

The application (107) is an algorithmic software engine providing functionality according to particular needs, desires, or particular implementations of the computer (102), particularly with respect to functionality described in this disclosure. For example, application (107) can serve as one or more components, modules, applications, etc. Further, although illustrated as a single application (107), the application (107) may be implemented as multiple applications (107) on the computer (102). In addition, although illustrated as integral to the computer (102), in alternative implementations, the application (107) can be external to the computer (102).

There may be any number of computers (102) associated with, or external to, a computer system containing computer (102), wherein each computer (102) communicates over network (130). Further, the term “client,” “user,” and other appropriate terminology may be used interchangeably as appropriate without departing from the scope of this disclosure. Moreover, this disclosure contemplates that many users may use one computer (102), or that one user may use multiple computers (102).

The following examples are merely illustrative and should not be interpreted as limiting the scope of the present disclosure.

### EXAMPLES

### General Procedures

### Materials

(3-aminopropyl)triethoxysilane (APTES, 99%), tetrachloroauric acid (HAuCl4·3H2O), tetrakis hydroxymethyl phosphonium chloride (THPC), poly-L-lysine hydrobromide (MW 150,000-300,000) (PLL) Anthracene, Pyrene, Benzo[a]pyrene, and Benz[a]anthracene were purchased from Sigma-Aldrich. Formaldehyde (37%), sulfuric acid (H2SO4, 100%), hydrogen peroxide (H2O2, 30%), potassium dihydrogen phosphate (KH2PO4) and 200-proof ethanol were obtained from Fisher Scientific (Hampton, NH). All the chemicals were used as received without further purification. Quartz slides were purchased from Fisher Scientific.

### Sensing

Surface Enhanced Raman Spectroscopy (SERS) measurements were acquired with a Renishaw inVia Raman microscope (Renishaw, U.K.) with 785 nm excitation wavelength and 55 μW laser power at the samples. Backscattered light was collected using a 63× water immersion objective lens (Leica, Germany) with a 20 s exposure time. The extinction measurements were performed on a Cary 5000 UV/Vis/NIR Varian spectrophotometer. Scanning Electron Microscopy (SEM) measurements were performed using a FEI Quanta 400 field emission SEM at an acceleration voltage of 20 kV scanning electron microscope. The SEM samples were prepared by evaporating a droplet of aqueous NS solution onto a silicon wafer.

### SERS Substrate Preparation

Cleaned quartz slides were modified with 0.01% w/v aqueous solution of poly-L-Lysine (PLL) (MW 150,000-300,000) for 20 minutes to facilitate the attachment of a dispersed monolayer of NSs on the quartz surface. The quartz substrates were cleaned by immersing in “piranha solution” (H₂SO₄:H₂O₂=3:1), followed by rinsing with deionized water (18.3 MΩ, Millipore). Au NSs were fabricated using a method previously described. NS of inner and outer radii [r₁, r₂]=[63, 86] with a strong dipole plasmon mode at 780 nm were used for the SERS studies. NS were immobilized by depositing 100 μL of the Au NS suspension on PLL coated quartz substrate with isolated wells (9 mm diameter) for a minimum of 6 hours. The quartz slides coated with Au NS film were rinsed with water and acetone followed by incubation with 10 μL of 100 μM PAH solution. Before acquiring the SERS spectra, the substrates were fully immersed in Milli-water.

### Calculation of the Optical Properties of the SERS Substrate

This was performed using COMSOL Multiphysics software. The nanoshell was modelled as a silica core of radius 60 nm coated with 14 nm Au layer on a quartz substrate. The junction of the fused dimer was smoothed to a curve of radius 3 nm. The dielectric constant of Au was obtained from Johnson & Christy. The refractive index of the silica core and the substrate was 1.5. The medium refractive index was 1.33 for NSs dispersed in aqueous solution. The electric field enhancement was calculated as |Eₑₓ/E₀|²×|Eₛₜₒₖₑₛ/E₀|², where the stokes shift was 350 cm⁻¹. The dimers simulated for field enhancement were filled with PAH inside the junction and under longitudinal polarized light. The PAH refractive index was taken to be 1.49.

### Computational Methods

The notation and the full procedure of the CaPE algorithm and an optional preprocessing method are described below.

### Preprocessing

The existence of a common background in the spectra for different PAHs will increase the correlation between PAHs and hence make demixing more difficult. Hence, a baseline removal algorithm may be used to remove this overall trend in the spectra. This step does not affect any spectral peaks. Baseline removal was used as a preprocessing method. This procedure was applied to the SERS data before all analyses.

### Characteristic Peak Extraction (CaPE)

Spectra of PAH mixtures may be simplified to better understand how the ML demixing works—we reduce the dimensionality of the spectra by only observing the most characteristic peaks (CPs) in each PAH component. This spectra compression step reduces the similarity between spectra caused by noisy non-characteristic peaks (NCPs). When one of the picked peaks is an NCP, how the mixture spectra distribute was visualized. In ane extreme case, all samples will lie on a straight line no matter the concentration ratio, and hence, the components can become unidentifiable. Therefore, the present inventors believe the identifiability may be improved by picking CPs and compressing the spectra before inputting the data into ML demixing methods.

However, when given a mixture whose components are unknown, it may become challenging to find CPs since 1) it may not be possible to refer to a library of spectra for the CP locations; 2) some components may have relatively low concentrations in the mixture, and hence the intensity of their CPs may be low as well; 3) some NCPs may have the same level of intensity as some low-intensity CPs. A nontrivial peak detector may be needed to distinguish between CPs and NCPs. Also, the compression algorithms previously proposed for NSNMF tend not to have an interpretation related to the SERS demixing task. Thus, in this disclosure, a simple yet effective algorithm is described, where the algorithm is able to reduce mixture spectra to a lower dimension and keep most of the important information.

### Notation

Let X∈ [symbol] ^{d×N} denote the input mixture spectra, where N is the number of recordings and d is the dimension. In the examples, d=1,738 and N ranged from 60 to 120. Let x∈X denote a single recording from X. Let Lₓ∈ [symbol] ^{d} be a binary vector whose ith element L_{x,i}=1 if there is a peak at xᵢ else 0. The CaPE algorithm contains two stages. In the first stage, a range of locations is estimated for each CP. CPs from all components in a mixture are considered. In the second stage, the mixture spectra is reduced to a lower dimension. The mixture spectra were reduced by applying max pooling over every estimated range of CP locations. Max pooling is an operation that selects only the maximum intensity over a given range; all others are discarded. The resulting vector will contain the intensities of the maximal CPs.

### Estimating Ranges of CP Locations: CaPE-Rank

Step 0 included smoothing. X may be smoothed by applying a smoothing kernel to each x. A moving average kernel with kernel size K was used for all experiments. A Gaussian kernel was tried, but our preliminary results showed that it is not as helpful as a moving average kernel.

Step 1 included peak detection. Peaks were detected for each x and obtain Lₓ. A peak detector was used whose only criterion is a minimum prominence of 0.02. Prominence is the vertical distance between a peak and its lowest contour line. Each x was normalized to have an intensity range of [0, 1]. Thus, this small prominence threshold sufficed to detect the reasonably sized peaks.

Step 2 included counting peaks. L_{X}, the count of all detected peaks for X, defined as L_{X}=Σ_{x∈X}Lₓ, was calculated.

Step 3 included selecting peaks. Select the top M′=M candidate peaks in terms of peak counts given in L_{X}. Suppose the indices for these M′ peaks are i₁, . . . , i_{M′}. Then, L_{X,M′} was obtained, where L_{X,M′,i}=L_{X,i} if i∈{i₁, . . . , i_{M′}}, else 0. After this step, typically it was observed that some selected peaks were very close to each other, which corresponds to the frequency shifts of peaks in different recordings.

Step 4 included clustering selected peaks. The selected peaks were clustered with a distance threshold Dₜ, i.e. the peaks in the same cluster will be at most Dₜ away from each other. After the clustering, there were M_{c}′ cluster, where ranges are denoted by Rⱼ, j=1, . . . , M′_{c}, where Rⱼ=[r_{j,l}, r_{j,u}] and 1≤r_{j,l}≤r_{j,u}≤d.

Step 5 included Aggregating Peak Counts. Since each cluster was considered as a result of the horizontal shift of one peak, all peak counts within a cluster were aggregated by summing them up to obtain a single peak count value Cⱼ for each cluster, i.e. Cⱼ=Σ_{i∈R}_{ⱼ}L_{X,M′,i}.

Step 6 included repeating steps 1-5. Step 1-5 were repeated with M′←M′+0.2M until M_{c}′≥M. Then, the top M clusters were picked in terms of the total counts Cⱼ as our final estimated ranges of CP locations R₍ⱼ₎, j=1, . . . , M, where R₍ⱼ₎ denotes the jth range ordered descendingly by the corresponding C₍ⱼ₎.

### Estimating Ranges of CP Locations: CaPE-Threshold

Steps 0-2 and steps 4-5 were the same as for CaPE-Rank.

Step 3 included selecting peaks. The candidate peak locations were selected with peak count ≥pN, where 0<p≤1. In other words, suppose the set of indices for these M′ peaks is I={i₁, . . . , i_{M′}}={i∈{1, . . . , d}|L_{X,i}≥pN}. Then, L_{X,M′} was obtained, where L_{X,M′,i}=L_{X,i} if i∈{i₁, . . . , i_{M′}}, else 0.

The above steps were not repeated in CaPE-Threshold. Therefore, the resulting M clusters are the estimated ranges of CP locations R₍ⱼ₎, j=1, . . . , M.

### Compressing Spectra to Lower Dimensions

Given R₍ⱼ₎, j=1, . . . , M, max pooling was applied over R₍ⱼ₎ to the input data. For the demixing, only the resulting intensities were needed. However, to evaluate the DCs afterward, including matching PAHs in the library and calculating AUPRC with the matched PAHs, setting the location of each peak also was needed. The cluster center was chosen for simplicity, and it turns out that this performs decently well. Let Mid (R₍ⱼ₎)=└(r_{(j),l}+r_{(j),u})/2┘ denote the center of R₍ⱼ₎. Then, let x′ denote the sparse spectrum created from x. Each of its entry is

$${x}_{i}^{′} = \{ \begin{matrix}{max}_{k ∈ {R}_{( j )}} {x}_{k} , & if ∃ j ∈ \{ 1 , … , M \} , s . t . i = Mid ( {R}_{( j )} ) \\ 0 , & otherwise\end{matrix} , ∀ i = 1 , … , d \qquad ( 1 )$$

Note that although x′ is still a d-dimensional vector, it is M-sparse. A spectrum that contains only the M nonzero entries of x′ is herein termed a compressed spectrum \tilde{x}. We only need to feed \tilde{x} into the demixing methods. By applying Eq. (1) to every x∈X, a set of sparse spectra X′∈ [symbol] ^{d×N} was obtained and a set of compressed spectra \tilde{X}∈ [symbol] ^{M×N} was obtained. In the examples, M«d.

### Comparing CaPE-Rank and CaPE-Threshold

The major difference is that CaPE-Rank iterates until the output has a given dimension M, while CaPE-Threshold does not iterate. Thus, CaPE-Threshold has simpler steps but may produce outputs of different dimensions for different inputs. They are also similar in the sense that CaPE-Rank picks the candidate peaks by the ranking of their counts, which is equivalent to a threshold of the M^{th} peak count. The intuition behind CaPE-Threshold is that since, ideally, every recording in the data should contain the CPs but not NCPs, the counts for CPs should be close to N, while the counts for NCPs might be much lower. Therefore, in CaPE-Threshold, the candidate peaks may be picked according to a threshold proportional to N. In the examples, the best value of M found for CaPE-Rank lay in [30, 50], and the best value of p found for CaPE-Threshold lay in [0.1, 0.2].

### Matching a Demixed Component (DC) to a PAH Using Similarity

The similarity between two spectra was defined as the inner product between them after normalizing each to range [0, 1]. The cosine similarity was not used because the l₂-norm was highly sensitive to NCPs and background noise in the spectra, even if they had low intensity. Suppose there are two spectra for the same PAH, where one is clean, noiseless, and only contains the CPs, while the other contains the same CPs but is noisier. Then, the noisier one will have a much larger l₂-norm since the spectra are high dimensional. In other words, two spectra will have a very different normalizing multiplier even if they have exactly the same CPs. This might cause an issue in the matching process—the similarities between different pairs of spectra may not have a consistent scale.

First the similarities between each DC and each PAH were calculated. Since each PAH had multiple recordings, the average of the similarities between the DC and each recording were taken. Then, the DC-PAH pair with the highest similarity was picked and the DC-PAH pairs containing any DC or PAH already matched were removed. This step was continued until every DC is matched to a PAH.

### Area Under the Precision-Recall Curve (AURPC)

Precision is the ratio between the number of detected CPs and the number of all detected peaks in a DC. Recall is the ratio between the number of CPs detected in a DC and the total number of CPs in the corresponding PAH. The precision-recall curve contains precision-recall pairs obtained by varying the peak detection threshold, which is the minimum height of a peak, from 0 to 1 by a 0.002 interval after normalizing the spectrum to range [0, 1]. A tolerance of 12 indices was allowed when counting if the peak locations match, which corresponds to around 10 cm⁻¹. If multiple peaks matched the same CP of a PAH, counting occurred only once.

### Implementation

All code was written in Python 3.7. The Python code by Ouedraogo et al. (2010) (W. S. B. Ouedraogo, A. Souloumiac, C. Jutten (2010) Non-negative Independent Component Analysis Algorithm Based on 2D Givens Rotations and a Newton Optimization, in 9th International Conference on Latent Variable Analysis and Signal Separation (St Malo, FRANCE), pp 522-+.) was used for NICA, the MATLAB code of SparseICA-EBM was used for SICA, and the FastICA function in the Python package Scikit-Learn was used for ICA. NICA and SICA only accept an input of d×C, where d is the dimension of spectra and C was a guess of the number of sources, while the data had a shape of d x N, where N»C is the number of observations. The PCA function in Scikit-Learn was used to extract the top C principal components before feeding the data into NICA or SICA. For NMF, the NMF function in Scikit-Learn was used. And for NSNMF, the Python package Nimfa was used for XRAY and SPA, as well as the existing data compression algorithms, including QR decomposition, structured random compression, and Count-Gauss. The AgglomerativeClustering function in Scikit-Learn was used for the clustering of peak counts, with n_clusters=None and distance_threshold=D.

### Hyperparameter Tuning

Grid search was used for all hyperparameter tuning. The demixing method and the data compression algorithm were tuned together if a compression algorithm was applied. For all demixing methods, the guess of the number of sources C was tuned from {2, 3, 4, 5, 6, 7, 8}. For ICA, the negentropy approximation function was tuned from {log cos h, exp, cube}. For NICA, 0.1 was used for the stop tolerance and 100,000 was used for the maximum number of iterations. Substantial differences were not found between the performance using different values for these two hyperparameters. For SICA, the sparsity parameter λ was tuned from {0.0001, 0.01, 1} and the smoothing parameter ϵ was tuned from {0.001, 0.1, 10}. For NMF, the regularization strength for the sources α_{W} was tuned from {0.01, 0.1, 1} and the regularization strength for the coefficient an was tuned from {0.01, 0.1, 1}. The implementation of NSNMF methods does not contain hyperparameters to tune. However, the data compression algorithms can still be tuned for NSNMF. The QR decomposition does not have any hyperparameters. For the structured random compression, the number of power iterations was tuned from {0, 1, 5, 20}, the oversampling parameter was tuned from {1, 5, 10, 20, 50} and the minimum compression level was tuned from {5, 10, 20, 40, 80}. For Count-Gauss, the oversampling factor was tuned from {5, 10, 20, 50}. For both variants of CaPE, K was tuned from {1, 5, 9} and Dₜ was tuned from {12, 24, 36, 48}. For CaPE-Rank, M was tuned from {30, 40, 50}. And for CaPE-Threshold, p was tuned from {0.05, 0.1, 0.2, 0.4}. These value ranges were all determined by the preliminary experiments.

### Example 1 Detection and Identification of PAHs Using SERS and Machine Learning

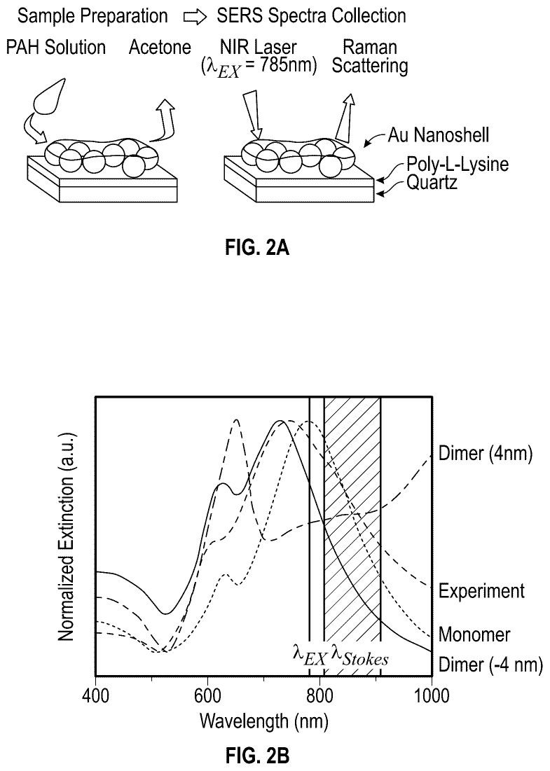

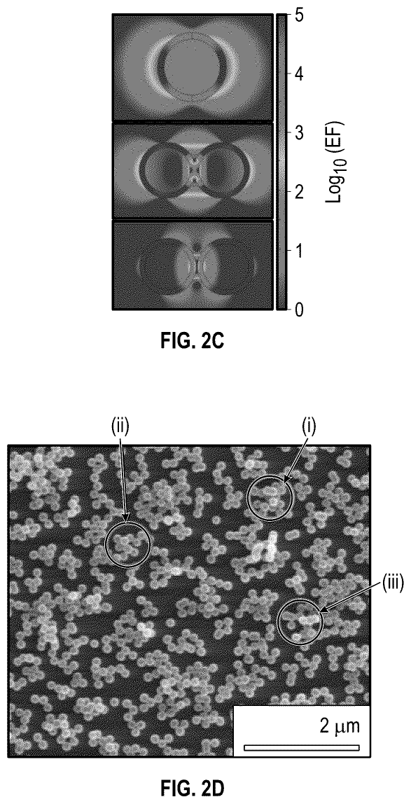

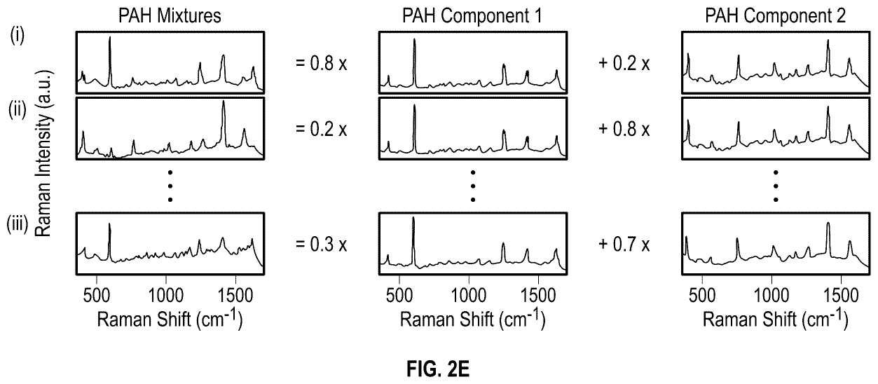

A schematic of the SERS substrate preparation and PAH detection according to one or more embodiments is shown in FIG. 2A. Au nanoshells (NS) with a hydrodynamic diameter of 165±5 nm were fabricated. Freshly prepared NS were deposited onto poly-L-Lysine coated quartz substrates (FIG. 2A), followed by drop-dry deposition of PAH solutions in acetone onto the prepared substrates. SERS spectra of the PAHs were acquired using a Renishaw inVia Raman microscope with a 785 nm laser wavelength and a laser intensity of 55 μW. The NS were characterized by UV-Vis-NIR extinction spectroscopy while in aqueous solution (FIG. 2B) and scanning electron microscopy (SEM, FIG. 2D). The experimental and theoretical extinction spectrum of the aqueous NS solution (monomer) shows a strong dipole plasmon mode at 745 nm at which corresponds with the 785 nm Raman pump laser (λ_{Ex} gray line). The strongest field enhancements for the NS aggregates are obtained at the junction between adjacent NSs: theoretical NS extinction spectra of various dimer configurations were simulated for dimers with a gap ranging from ±4 nm (where negative gap distances refer to overlapping or fused NSs). The experimental extinction spectrum of the NSs appears to indicate the presence of both monomer and dimer plasmons in solution based on its spectral location between the calculated monomer and dimer plasmon spectral peaks. All monomer/dimer NS spectra span the Raman pump laser wavelength (785 nm) and the Stokes wavelength range. Spatial distributions of the calculated electromagnetic field enhancement for the monomer NS and for NS dimers with a ±4 nm gap is shown in FIG. 2C. Although the maximum electromagnetic field enhancement occurs near the junction of dimers, there is still significant enhancement at the surface of the NS monomers. The SEM image in FIG. 1D shows both the size distribution and the morphology of the NSs. Three random areas in the SEM image are highlighted to represent different SERS collection areas. SERS spectra of PAH mixtures are shown in FIG. 2E in corresponding colors to illustrate the potential variation in SERS spectra from various collection areas on different substrates.

According to one or more embodiments, a schematic representation of how to extract information about the qualitative and quantitative content of a multicomponent sample from its SERS spectra is shown in FIG. 2E. Given the spectra of a PAH mixture, ML methods can computationally demix the mixture and produce estimates of the underlying sources, as well as the mixing weight for each source. For the example illustrated here, the 1^{st} mixture spectrum is a mixture of 0.8 of unit Component 1 and 0.2 unit of Component 2. Similarly, the other spectra can be demixed into various concentrations of Component 1 and Component 2.

### Example 2 ML-Based Demixing Algorithm

In one or more embodiments, given an observation of a D-dimensional mixed spectrum xᵢ, it is demixed as

$${x}_{i} = {\sum }_{j = 1}^{\hat{C}} {w}_{i j} {s}_{j} ,$$

where wᵢⱼ∈ [symbol] is the mixing weight of each estimated source sⱼ∈ [symbol] ^{D} and Ĉ is the number of sources. For a set of N observations X=[x₁| . . . |x_{N}], this can be written as X=SW, where X∈ [symbol] ^{D×N}, S∈ [symbol] ^{D×Ĉ}, and W∈ [symbol] ^{Ĉ×N} For a better demixing result, one or more embodiments of the present invention first compress the input data to M dimensions, where M«D. Let \tilde{X} denote the compressed spectra. The complete procedure of demixing includes: Part (1), obtain \tilde{X} from X, and Part (2), solve \tilde{X}=\tilde{S}\tilde{W}, where \tilde{X}∈ [symbol] ^{M×N}, \tilde{S}∈ [symbol] ^{M×Ĉ}, and \tilde{W}∈ [symbol] ^{Ĉ×N}. Herein, any procedure designed to solve Part (1) is referred to as a data compression algorithm and Part (2) referred to as a demixing method. It is expected that \tilde{X} contains only information about the CPs, which becomes trivial if there is access to clean, noiseless spectra X_{CP}. For example, \tilde{X} could be as simple as all peak heights in X_{CP}. However, in practice, typically X=X_{CP}+Z, where z includes NCPs and background noise.

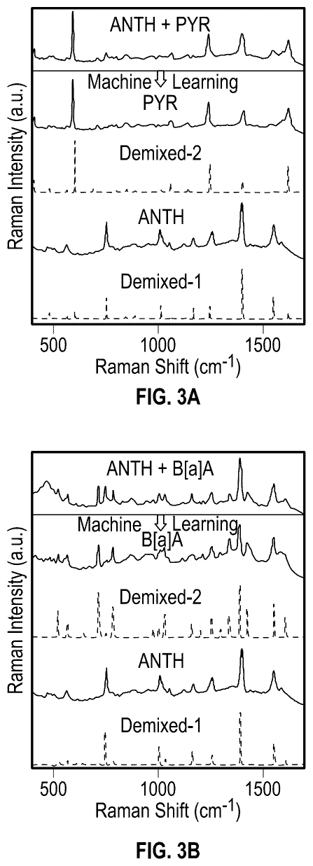

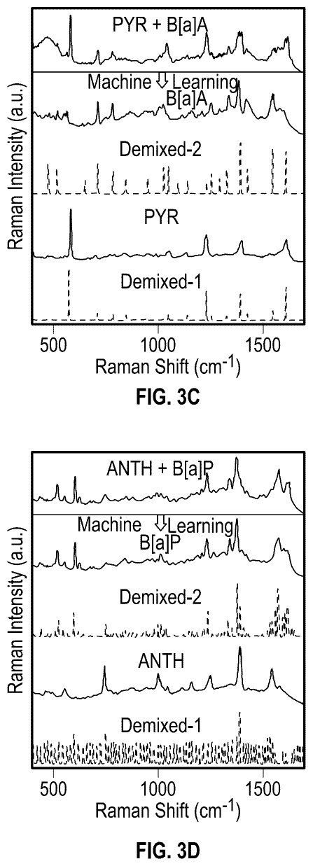

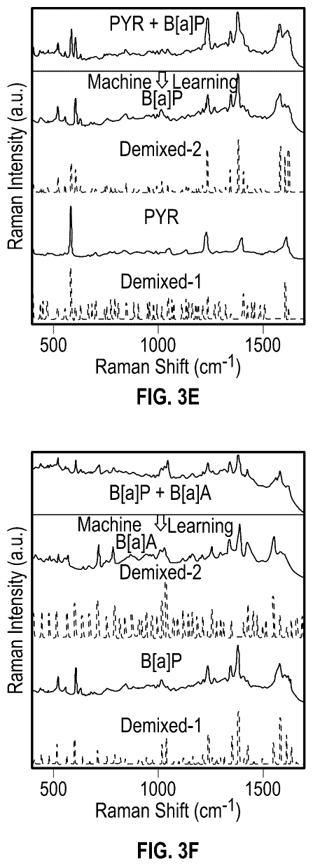

According to one or more embodiments, demixing of SERS spectra of mixtures with two PAHs are shown in FIGS. 3A to 3F. Four PAHs, Anthracene (ANTH), Pyrene (PYR), Benzo[a]pyrene (B[a]P), and Benz[a]anthracene (B[a]A), were selected from the U. S. Environmental Protection Agency's priority contaminants list to produce different mixtures to test the capability of the machine learning-based demixing algorithm. These PAHs were selected based on their environmental prevalence as well as their structural and spectral similarity. High intensity peaks in the SERS spectra of each PAH were selected as ground truth peaks (GTP), on which the quality of the spectra produced by the demixing algorithm was evaluated. The demixing algorithms according to one or more embodiments were first tested on the simplest multicomponent spectra: SERS spectra of a mixture of two PAHs. As shown in FIGS. 3A-3F, SERS spectra of 1:1 mixtures of ANTH: PYR; ANTH: B[a]P; ANTH: B[a]A; PYR: B[a]A; PYR: B[a]P; and B[a]P: B[a]A were obtained. For each PAH mixture, 50-100 SERS spectra were collected from different areas of the substrate and with PAH mixtures specially prepared by varying their relative concentrations. This was done to provide the necessary variation between PAH SERS features needed for spectral separation and to meet the requirements of the demixing algorithms tested. Variation in the PAH SERS signals was created artificially in this manner, to show the capability of the SERS-ML demixing methodology. The demixing algorithms used all spectra available for each PAH mixture to produce spectra of the components of the mixture, referred to as demixed components (DCs). For each mixture, all of the strategies were able to accurately determine that the number of components \hat{N}_{c}=2 and produced spectra for each component. \hat{N}_{c} was selected from {2, 3, . . . , 8} and the selected number corresponded to the optimal objective value optimized by the demixing methods. An additional algorithm was employed to match the DCs to different PAHs based on spectral similarity. The DCs produced from the best performing demixing algorithms, CaPE+NMF and CaPE+NICA, and the SERS spectra of the actual components of each PAH mixture are shown in FIGS. 2A-2F. Most of the major GTP present in the PAH SERS spectra are also present in the corresponding DCs for each mixture, while most of the unimportant peaks or noisy peaks are ignored by CaPE and all set to 0 in the DCs. The exception is for mixtures containing B[a]P (FIGS. 3D, 3E, and 3F). The demixing algorithm was only able to produce noise-free spectra for one component: B[a]P. The other component of each mixture, while containing all of the characteristic peaks of the respective PAH, also contained a significant amount of noise, which prevented a visual matching of the DC to the correct PAH component. However, it did not prevent accurate matching by the algorithm.

### Example 3 Two-Component Mixtures

According to one or more embodiments of the present disclosure, the best demixing was obtained for the ANTH and PYR (FIG. 2A) and the ANTH and B[a]A (FIG. 3B) mixtures. All peaks present in each of the DCs matched the peaks of the corresponding PAH SERS spectra well, in both location and relative intensity. The demixing algorithm performed well in correctly attributing close peaks corresponding to the different PAHs. For the ANTH and B[a]A mixture (FIG. 2B), several minor features in the B[a]A SERS spectra are not present in the corresponding DC (Demixed-2). However, the majority of the most intense SERS peaks could be directly attributed to the B[a]A modes appearing in the corresponding DC. The demixing of PYR and B[a]A (FIG. 3C) also produces DCs that match the corresponding PAH SERS spectra well but with minor errors. The DC for PYR (Demixed-1) contains a few features with relatively low intensities corresponding to B[a]A modes at ˜1260, 1433, and 1554 cm¹. Additionally, the DC for B[a]A (Demixed-2) contains features at ˜1616, 1237, 1102, 956, 853, and 659 cm⁻¹ that are either too intense or are incorrectly attributed to B[a]A. None of these errors prevent the DCs from being easily matched visually or computationally to the correct PAH. In contrast, the DCs from the mixture of B[a]P and ANTH (FIG. 2D), B[a]P and PYR (FIG. 3E), and B[a]P and B[a]A (FIG. 3F) are not as easy to visually match as the others. The peaks in DCs produced for these mixtures are much less sparse than for the other mixtures previously discussed. The DCs corresponding to B[a]P in FIGS. 3D-F match the B[a]P SERS spectrum. However, instead of the DCs containing only one peak that corresponds to each B[a]P SERS feature like the other DCs previously discussed, they contain several peaks with different intensities clustered together that match the overall B[a]P SERS peak shapes. There is also the presence of some incorrectly attributed peaks in each DC. For the mixture of B[a]P and ANTH (FIG. 2D), the DC matched to B[a]P contains a feature at ˜1398 cm⁻¹ that corresponds only to ANTH. Likewise, for the mixture of B[a]P and PYR (FIG. 3E), there are features in the DC matched to B[a]P at ˜1408 and 590 cm⁻¹ that are respectively too intense and correspond only to PYR. For the mixture of B[a]P and B[a]A (FIG. 3F), the DC matched to B[a]P contains features at ˜1554, 1430, 1041, and 731 cm⁻¹ that are either too intense or correspond only to B[a]A. The DCs corresponding to the other PAHs for the mixtures in FIG. 3D-F contain a significant amount of noise. The noise is present at the same intensity as for the relevant peaks, making it difficult to visually distinguish these peaks from noise. The only exception is the DC corresponding to PYR in FIG. 3E. The characteristic PYR SERS peaks at ˜1608, 1408, 1238, 590 and 407 are present in the corresponding DC at a slightly higher intensity than the noise. Overall, the presence of noise does not prevent these DCs from being matched to the correct PAH algorithmically.

### Example 4 Applying ML-Based Demixing Algorithms

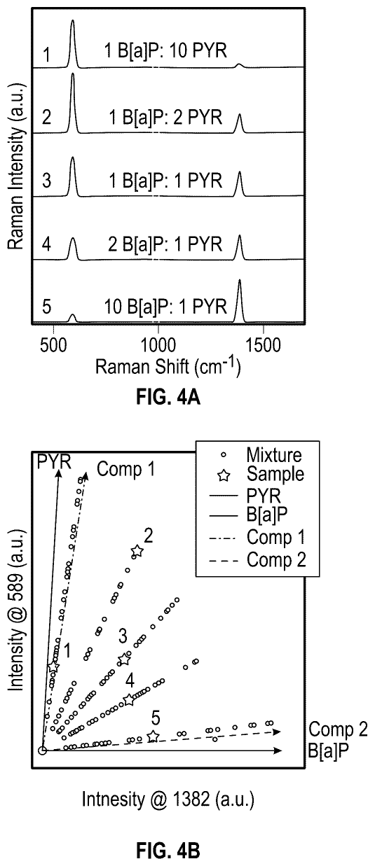

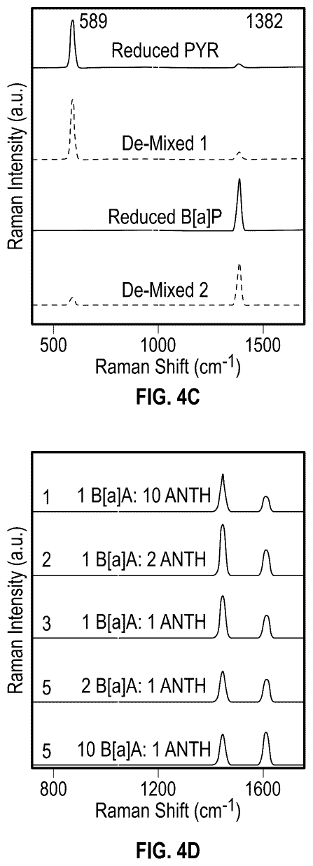

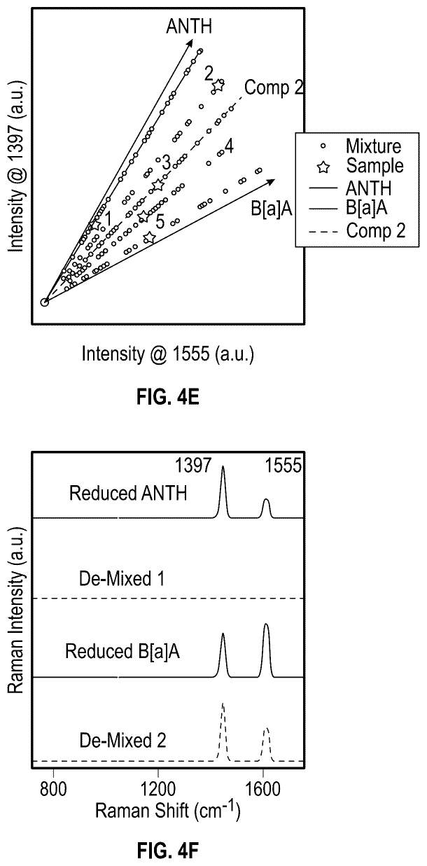

According to one or more embodiments of the present disclosure, FIGS. 4A-4F show the ML algorithm used to identify the PAH mixture components according to one or more embodiments of the present disclosure. Instead of visualizing the full spectrum of PYR and B[a]P, for simplicity here one or more embodiments of the present disclosure only focus on the intensities of two frequencies, 589 cm⁻¹ and 1382 cm⁻¹, which are the spectral locations of the highest amplitude peaks of PYR and B[a]P, respectively. Thus, each spectrum is reduced from a 1,738-dimensional vector to a 2-dimensional vector. A Gaussian pulse was used to broaden each peak for visualization purposes. The calculated spectra of mixtures of two PAHs with different concentration ratios (CRs) are presented in FIG. 4A, and mixtures with different absolute concentrations are shown in FIG. 4B. The pure components (shown as solid arrows) serve as the extreme vectors of a cone that contains all possible mixtures. Mixtures with higher absolute concentrations are further from the origin. Also, mixtures with the same CR lie on a ray starting from the origin. The examples from FIG. 4A are labeled as stars. A comparison between the demixed components (DCs) estimated by NMF and the pure components is shown in FIG. 4C. Some errors are observed in the DCs (also shown as dashed arrows in FIG. 4B): DC 1 has a greater than expected x coordinate and DC 2 has a greater than expected y coordinate. When projected back to the full spectra, these errors become spurious peaks or peaks with incorrect relative intensities. This illustrates that the problem will become more difficult when the extreme vectors span a much smaller space as shown in FIGS. 4D-4F. The same algorithm can only separate one of the components while missing the other. Also, in practice, there are more than 2 peaks in the spectra, making identifying extreme vectors much more difficult for the ML demixing.

### Example 5 More than Two Components in a Mixture

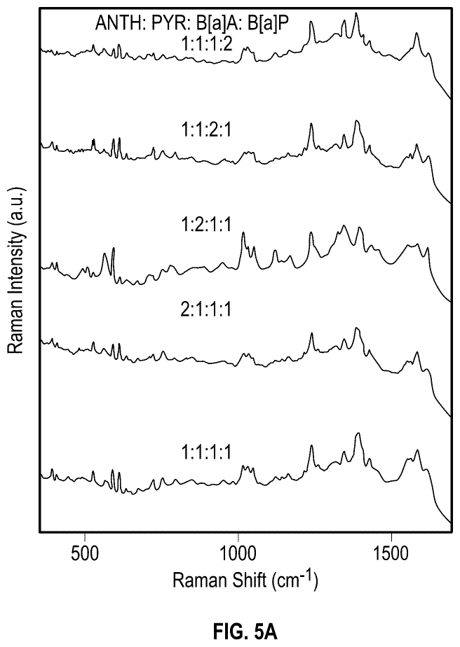

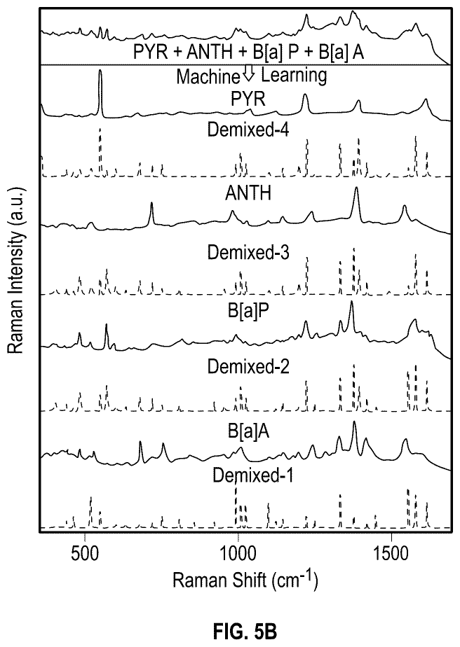

According to one or more embodiments of the present disclosure, FIGS. 5A and 5B show the demixing strategies tested on more complex multicomponent spectra: SERS spectra of a mixture of the four PAHs. SERS spectra of mixtures of ANTH, PYR, B[a]P, and B[a]A in various ratios were collected (FIG. 5A). The relative ratios of PAHs used in demixing the spectra of four PAHs were similar to the ratios used for demixing two PAHs. They both included spectra of the PAHs mixed equally and spectra with each PAH at a higher concentration than the other(s). All mixture SERS spectra contain features from the individual PAHs. However, there is significant overlap in the major peaks from each of the different PAHs in the 1300 cm⁻¹ to 1500 cm⁻¹ range, making the separation and identification more challenging.

The DCs produced from the demixing algorithm and the SERS spectra of the components of the PAH mixture are shown in FIG. 4B. Unlike the demixing results from 2 PAHs, the demixing of four PAHs resulted in DCs more unlike the PAH SERS spectra. This is also reflected in the quantitative assessment of the demixing. The best result is the DC corresponding to PYR (Demixed-4). The five most intense peaks match the most intense peaks in the PYR SERS spectrum extremely well. However, there are a few lower intensity peaks present in the DC that do not match PYR. The Demixed-2 spectrum that corresponds to B[a]P also has a similar result with most of the major peaks present with some low intensity noise. There is also the absence of a distinguishing B[a]P feature at ˜1350 cm⁻¹ in the Demixed-2 spectrum. The Demixed-3 and Demixed-1 spectra, corresponding to ANTH and B[a]A respectively, do not match their respective SERS spectra as well, as compared to the other DCs. There are also some misattributed or noisy peaks with high intensity and the DCs are missing some characteristic peaks. Despite these errors, the simple matching algorithm is still able to match them to the correct PAHs. Also, CaPE successfully picks up the CP locations while ignoring most of the unimportant and background peaks.

### Example 6 Comparing Demixing Algorithms

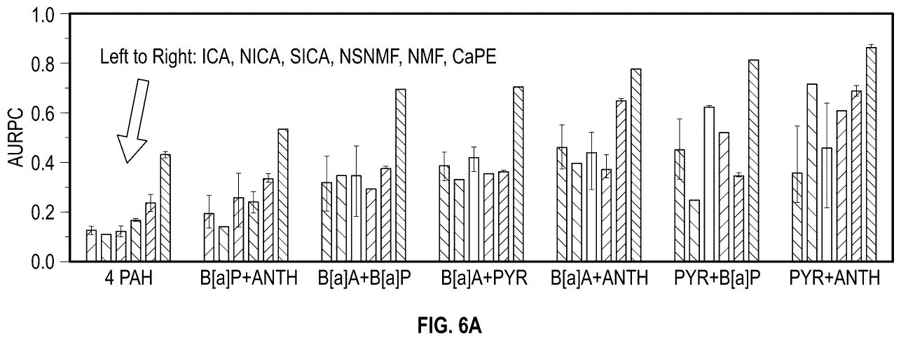

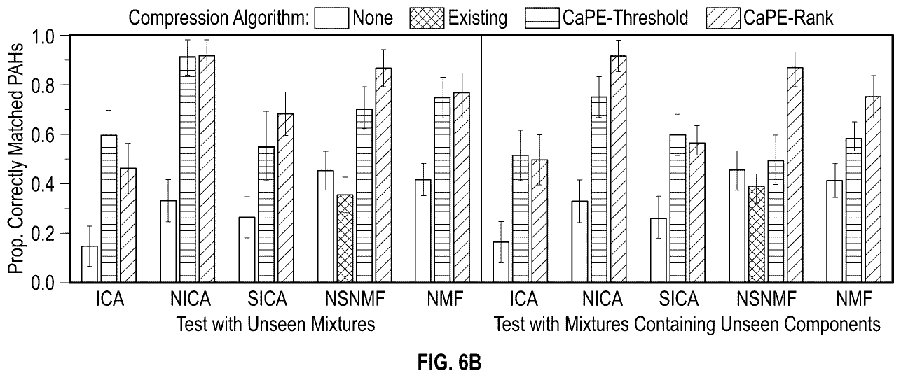

According to one or more embodiments of the present disclosure, the performance of different demixing methods with or without using the CaPE algorithm is shown in FIGS. 6A and 6B. FIG. 6A shows the area under the precision-recall curve (AUPRC) for known mixtures, which demonstrates the best possible performance for each algorithm, while FIG. 6B shows if the demixed components (DCs) match the PAHs for unknown mixtures, demonstrating the generalization performance. The AUPRC measures how well the DCs reconstruct the matched PAHs in terms of the recovery of CPs. In one or more embodiments, a similarity metric close to the cosine similarity is used for the matching process. A perfect recovery of the underlying PAH will lead to an AUPRC close to one. Other applicable data compression algorithms may include NSNMF, including QR decomposition, structured random compression, and Count-Gauss. By using CaPE, the AUPRCs for all mixtures are improved by a large margin, especially for the more difficult ones, like B[a]P+ ANTH and the 4-mixture, where the AUPRCs are relatively lower. These results indicate that CaPE is able to extract CPs effectively. Each spectrum processed by CaPE has only 18 to 106 dimensions, which is much lower than the original 1,738 dimensions of the original acquired spectra. These lower-dimensional representations of mixture spectra also make it much easier to identify which PAH each DC is, as shown in FIG. 6B. The performance of matching DCs to PAHs averaged over multiple tests are plotted. In each test, one mixture is left unseen (i.e., unknown) and use the rest to tune the hyperparameters. The task in the right panel is more difficult, since the test mixtures only contain unseen PAH components. CaPE-Rank and CaPE-Threshold are two variants of CaPE. The proportion of correctly matched PAHs is calculated by matching the DCs to a small library of 8 PAHs using a similarity metric. Four of the PAHs are not present in any mixtures. Thus, if a demixing method is not performing well, it may miss all the PAHs. Without CaPE, existing demixing methods can match half of the correct PAHs at most. For NSNMF, using existing data compression algorithms reduces the performance. However, CaPE enables the demixing methods to recover many more components correctly. NICA+CaPE is almost able to match all the PAH components stably in both of the test settings in (B).

### Advantages

Past work attempting to demix PAH mixtures required curated libraries like Raman spectra, but such curated libraries for SERS do not yet exist, and if they are generated they may be incomplete, highly substrate-dependent, or possess procedure-dependent artifacts. In addition, the variability of SERS measurements in different spatial regions of the substrate, conventionally considered a nuisance, is in fact, from an ML or information theoretic point of view, a desired feature because varying concentration ratios of components provides more information useful for the demixing algorithm (FIG. 4B). This feature is particularly essential for unsupervised demixing without the use of libraries. Also, there is a lack of attention to frequency shifts of SERS peaks due to variations in molecular orientation and binding affinity to SERS substrates, a characteristic property of SERS. This might worsen the performance of widely-used ML methods, like ICA, NMF and their variants. One or more embodiments of the present invention provides a new computational-sensing-based technique for demixing mixtures that does not require any knowledge of the underlying mixture components. It employs a novel co-design of chemical sensing that measures SERS samples at various points on a substrate and a demixing strategy that can deal with frequency shifts and low-intensity CPs in SERS spectra. And the key of the strategy is CaPE.

According to one or more embodiments of the present disclosure, CaPE uses a count-based criterion because (1) some components may have relatively low concentrations in the mixture, and hence the intensities of all their peaks are low, and (2) some NCPs or noise may have the same level of intensity as some low-intensity CPs. By counting the number of peak occurrences at a particular location (wavenumber) across all recordings, hotspots are found where CPs are likely to locate. Ideally, the count for every CP should be close to the total number of recordings, whereas the counts for NCPs should tend to be much lower since their locations may be shifted over the entire Stokes spectral region. CaPE also has a spatial maximum pooling operation, commonly used in the architecture of convolutional neural networks to enable invariance to small local shifts of objects in the input image, a critical part of successful computer vision algorithms.

Based on the quantitative evaluations described in one or more embodiments, CaPE offers a great value for the problem of SERS demixing: more CPs will be assigned to the correct DC and more DCs will be matched to the correct PAHs. In addition, CaPE also compresses the data and relieves the constraints on time or space complexity when choosing demixing methods. CaPE is necessary for achieving the best possible demixing performance, as shown in FIG. 6A, where the hyperparameters in the demixing method and data compression algorithm are jointly tuned according to the average performance. Also, CaPE is not only effective in a single mixture, but it also works for other unknown mixtures, no matter which demixing method it is combined with. This was shown in FIG. 6B, which tests whether the algorithm can generalize by leaving one mixture unseen and only using the rest to tune the hyperparameters. Despite these gains, CaPE only has three hyperparameters, for each of which are searched over 3 or 4 values. Hence, the tuning effort required is small. Also, although a library of known mixtures during tuning is used, in practice, a library is not needed for one having some prior knowledge about the spectra of the potential components. And for evaluation, since the demixed components are currently matched to a library of known chemicals, new chemicals can be discovered and added to the library if they do not match any existing ones with high confidence. It is also possible to avoid using a library by evaluating the algorithms on some downstream tasks. Another promising direction is to explore how CaPE-enhanced unsupervised demixing compares with non-blind or semi-blind demixing methods that use libraries or dictionaries. It is possible to obtain good demixing results, but a large dictionary may increase the running time of these already time-consuming algorithms. And if the mixture contains a component that is not in the dictionary, it may be added to the dictionary online, which is similar to what an unsupervised approach does.

While only a limited number of embodiments have been described, those skilled in the art having benefit of this disclosure will appreciate that other embodiments can be devised which do not depart from the scope of the disclosure. For example, from FIGS. 3D, 3E and 3F, CaPE still picked some NCP locations, which indicates that the assumption about the more spread-out distribution of NCPs and noisy peaks might be violated in some cases. This peak range selection may also confuse the demixing method, since if NCPs and noisy peaks are included, the similarity between different components will increase. Hence it becomes more difficult in such cases for demixing methods to separate the mixture. It is also possible to refine the criterion of peak selection in CaPE to improve it. Furthermore, it is possible to estimate some of the hyperparameters directly from data, making the tuning step less needed. For example, it is possible to estimate the distance threshold for clustering peak counts by just gauging from its distribution. In this way, it is possible to use different thresholds for different characteristic peaks, making the algorithm more flexible.

For any demixing algorithm, if two components have the same spectral peaks then demixing is impossible, as this violates the requirement (the source matrix being full-rank) for the identifiability of NMF. In these cases, the bottleneck of the demixing performance is not CaPE but the demixing algorithm. Nevertheless, CaPE is still able to improve the performance to some degree given the uncertainty/ambiguity caused by overlapping peaks and noise. Accordingly, the SERS-ML tandem methodology disclosed in one or more embodiments of the present disclosure will open the door for rapid diagnostic, fieldable identification, and detection of at-risk chemicals based on their molecular structure.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for analyzing a mixture, comprising:
obtaining a first spectrum of the mixture comprising a plurality of components;
selecting at least one position on the spectrum; and
estimating a mixing weight for each of the components using an algorithm based on an intensity of the at least one position.

2. The method of claim 1, wherein the components in the mixture include one or more of polycyclic aromatic hydrocarbons (PAHs).

3. The method of claim 1, wherein the first spectrum is a Raman scattering spectrum.

4. The method of claim 1, wherein the first spectrum is obtained by Surface-Enhanced Raman Spectroscopy (SERS).

5. The method of claim 1, wherein the first spectrum is obtained on a nanostructured metallic substrate.

6. The method of claim 1, further comprising obtaining a second spectrum of one or more of the components as an input of the algorithm.

7. The method of claim 1, wherein the first spectrum is an averaged spectrum of a plurality of measurements,

8. The method of claim 1, wherein the algorithm comprises a compression algorithm and a de-mixing algorithm.

9. The method of claim 8, wherein the compression algorithm comprises a machine learning algorithm.

10. The method of claim 9, wherein the machine learning algorithm comprises a clustering algorithm.

11. A system for analyzing a mixture, comprising:
a spectrometer configured to obtain a first spectrum of the mixture comprising a plurality of components;
a processor configured to select at least one position on the spectrum and estimate a mixing weight for each of the components using an algorithm based on an intensity of the at least one position.

12. The system of claim 11, wherein the components in the mixture include one or more of polycyclic aromatic hydrocarbons (PAHs).

13. The system of claim 11, wherein the spectrometer is a Raman spectroscopy.

14. The system of claim 11, wherein the first spectrum is obtained by Surface-Enhanced Raman Spectroscopy (SERS).

15. The system of claim 11, wherein the first spectrum is obtained on a nanostructured metallic substrate.

16. The system of claim 11, wherein the spectrometer is configured to obtain a second spectrum of one or more of the components as an input of the algorithm.

17. The system of claim 11, wherein the first spectrum is an averaged spectrum of a plurality of measurements.

18. The system of claim 11, wherein the algorithm comprises a compression algorithm and a de-mixing algorithm.

19. The system of claim 18, wherein the compression algorithm comprises a machine learning algorithm.

20. The system of claim 19, wherein the machine learning algorithm comprises a clustering algorithm.
